(19) United States
(12) Patent Application Publication
(10) Pub. No.: US 2022/0352738 A1
(43) Pub. Date: Nov. 3, 2022

(54) CHARGING CONTROL METHOD OF POWER SUPPLY EQUIPMENT AND POWER SUPPLY EQUIPMENT

(71) Applicant: Joulwatt Technology Co., Ltd., Hangzhou (CN)

(72) Inventor: Pitleong Wong, Hangzhou (CN)

(73) Assignee: Joulwatt Technology Co., Ltd., Hangzhou (CN)

(21) Appl. No.: 17/732,575

(22) Filed: Apr. 29, 2022

(30) Foreign Application Priority Data
Apr. 30, 2021 (CN) 202110484897.X

(51) Int. Cl. H02J 7/00

(52) U.S. Cl. CPC H02J 7/007182; H02J 7/0048; H02J 2207/20

(57) ABSTRACT

A charging control method of power supply equipment and power supply equipment are provided. The power supply equipment includes a power stage circuit and a battery. An input power supply charges the battery through the power stage circuit. The power stage circuit includes a linear regulator and a switched capacitor converter. The linear regulator is connected with the switched capacitor converter. The linear regulator and/or the switched capacitor converter are/is selected for charging management according to charging power of the battery and/or a voltage of the battery. The charging control method can achieve relatively high charging efficiency when the battery is charged with a large current, and can achieve accurate control of the voltage of the battery when the battery is charged with a small current.

### CROSS REFERENCE TO THE RELATED APPLICATIONS

This application is based upon and claims priority to Chinese Patent Application No. 202110484897.X, filed on Apr. 30, 2021, the entire contents of which are incorporated herein by reference.

### TECHNICAL FIELD

The present disclosure relates to the technical field of power electronics, and in particular, to a charging control method of power supply equipment and power supply equipment.

### BACKGROUND

In the prior art, adapters are commonly used to power or charge power supply equipment. The prior power supply equipment mostly uses a two-level switching step-down circuit as a power circuit. The two-level step-down circuit can meet the withstand voltage requirements of a low-voltage system, however, in case of a higher input voltage, the withstand voltage requirements can hardly be satisfied, and when a ratio of the input voltage to a voltage of the battery is relatively large, it is difficult to achieve high efficiency. Additionally, when the ratio of the input voltage to the voltage of the battery is relatively small and the battery is charged with a lower current, it is difficult for the two-level step-down circuit to achieve accurate control of the voltage of the battery.

### SUMMARY

An objective of the present disclosure is to provide an efficient charging control method of power supply equipment and power supply equipment, which solves the problem of low charging efficiency and difficulty in achieving voltage regulation of power supply equipment in the prior art.

Based on the above objective, the present disclosure provides a charging control method of power supply equipment. The power supply equipment includes a power stage circuit and a battery. An input power supply charges the battery through the power stage circuit. The power stage circuit includes a linear regulator and a switched capacitor converter. The linear regulator is connected with the switched capacitor converter. The linear regulator and/or the switched capacitor converter are/is selected for charging management according to charging power of the battery and/or a voltage of the battery.

Optionally, sampling the voltage of the battery, adjusting an input voltage of the power stage circuit according to the voltage of the battery, where when the switched capacitor converter performs charging management, a ratio of the input voltage of the power stage circuit to the voltage of the battery may be in a first range. When the linear regulator performs charging management, the ratio of the input voltage of the power stage circuit to the voltage of the battery may be in a second range.

Optionally, when the switched capacitor converter performs charging, an input voltage of the power stage circuit may increase with the voltage of the battery.

Optionally, the input voltage of the power stage circuit may increase stepwise with the voltage of the battery.

Optionally, the linear regulator may be connected in parallel with the switched capacitor converter.

Optionally, if a voltage difference between a nominal voltage of the battery and the voltage of the battery is greater than a first threshold and the charging power of the battery is greater than a second threshold, the switched capacitor converter may perform battery charging management, and the linear regulator may be disabled.

Optionally, the first range may be set according to power loss of battery charging and an conversion ratio of the input voltage of the power stage circuit to the voltage of the battery.

Optionally, if a voltage difference between a nominal voltage of the battery and the voltage of the battery is less than a first threshold, the linear regulator may perform battery charging management, and the switched capacitor converter may be disabled.

Optionally, the linear regulator may be connected in series with the switched capacitor converter.

Optionally, if a voltage difference between a nominal voltage of the battery and the voltage of the battery is greater than a first threshold and the charging power of the battery is greater than a second threshold, the switched capacitor converter may perform battery charging management, and the linear regulator operates in a direct mode and does not participate in the battery charging management, alternatively, the linear regulator operates in a linear adjustment mode and participates in the battery charging management.

Optionally, when the linear regulator operates in a linear management mode, a voltage drop of the linear regulator may be in a third range.

Optionally, the input voltage of the power stage circuit may be adjusted according to the voltage of the battery, and the first range may be set according to power loss of battery charging, a voltage drop of the linear regulator, and an ideal conversion ratio of the input voltage of the power stage circuit to the voltage of the battery.

Optionally, if a voltage difference between a maximum nominal voltage of the battery and the voltage of the battery is less than the first threshold, the linear regulator may perform battery charging management, and the switched capacitor converter may operate in a direct mode. A difference between the input voltage of the power stage circuit and a sum of the voltage of the battery, a voltage drop of the linear regulator, and a voltage drop of the switched capacitor converter may be in a fourth range.

Optionally, if the voltage difference between the nominal voltage of the battery and the voltage of the battery is less than the first threshold, the linear regulator may perform battery charging management, and the switched capacitor converter may operate in a normal step-down state. A difference between the input voltage of the power stage circuit and a sum of the voltage of the battery, a voltage drop of the linear regulator, and a voltage drop of the switched capacitor converter may be in a fifth range.

Optionally, when the linear regulator and the switched capacitor converter do not operate simultaneously, at least one switching device in the switched capacitor converter may be reused as a power device of the linear regulator.

The present disclosure further provides power supply equipment, including a power stage circuit and a battery. An input power supply charges the battery through the power stage circuit. The power stage circuit includes a linear regulator and a switched capacitor converter. The linear regulator is connected in parallel or series with the switched capacitor converter. The linear regulator and/or the switched capacitor converter are/is selected for charging management according to charging power of the battery and/or a voltage of the battery.

Optionally, the voltage of the battery may be sampled, an input voltage of the power stage circuit may be adjusted according to the voltage of the battery, and when the switched capacitor converter performs battery charging management, a ratio of the input voltage of the power stage circuit to the voltage of the battery may be in a first range. When the linear regulator performs charging management, the ratio of the input voltage of the power stage circuit to the voltage of the battery may be in a second range.

Optionally, when the switched capacitor converter is configured for charging, the input voltage of the power stage circuit may increase with the voltage of the battery.

Optionally, when the linear regulator is connected in parallel with the switched capacitor converter, if a voltage difference between a nominal voltage of the battery and the voltage of the battery is greater than a first threshold and the charging power of the battery is greater than a second threshold, the switched capacitor converter may perform battery charging management, and the linear regulator may be disabled. If the voltage difference between the nominal voltage of the battery and the voltage of the battery is less than the first threshold, the linear regulator may perform battery charging management, the switched capacitor converter may be disabled.

Optionally, when the linear regulator is connected in series with the switched capacitor converter, if a voltage difference between a nominal voltage of the battery and the voltage of the battery is greater than a first threshold and the charging power of the battery is greater than a second threshold, the switched capacitor converter may perform battery charging management, and the linear regulator may be enabled. If a voltage difference between a maximum nominal voltage of the battery and the voltage of the battery is less than the first threshold, the linear regulator may perform battery charging management, and the switched capacitor converter may operate in a direct mode or a normal step-down state. A difference between an input voltage of the power stage circuit and a sum of the voltage of the battery, a voltage drop of the linear regulator, and a voltage drop of the switched capacitor converter may be in a fourth range.

Optionally, the switched capacitor converter may include a first capacitor, a first switch transistor, a second switch transistor, a third switch transistor, and a fourth switch transistor. The first switch transistor may include a first terminal receiving an input voltage, and a second terminal connected with a first terminal of the second switch transistor. A second terminal of the second switch transistor may be connected with a first terminal of the third switch transistor. A second terminal of the third switch transistor may be connected with a first terminal of the fourth switch transistor. A second common connection terminal of the second switch transistor and the third switch transistor may be connected to an anode of the battery. The first capacitor may include a first terminal connected with a first common connection terminal of the first switch transistor and the second switch transistor, and a second terminal connected with a third common connection terminal of the third switch transistor and the fourth switch transistor. If the charging power of the battery is greater than a second threshold, the switched capacitor converter may perform battery charging management.

Optionally, the linear regulator may include a current sampling circuit, a voltage sampling circuit, a power transistor, and a regulating circuit, and the current sampling circuit may sample a battery charging current and may output a current sampling signal. The voltage sampling circuit may sample the voltage of the battery and may output a battery voltage sampling signal. The regulating circuit may receive the voltage sampling signal, the current sampling signal, and a battery voltage reference signal, and may output a first control signal. The power transistor may include a first terminal receiving the input voltage, and a second terminal connected with an anode of the battery, a control terminal of the power transistor may receive the first control signal, and an operating state of the power transistor may be controlled according to the first control signal.

Compared with the prior art, the present disclosure has the following advantages: the power circuit of the present disclosure includes the linear regulator and the switched capacitor converter, and at least one of them is selected for charging management according to the needs, which can take into account the charging efficiency and the control accuracy of the voltage of the battery. The input voltage of the power supply equipment can be adjusted in real time according to the voltage of the battery, such that the input voltage follows the voltage of the battery according to the needs, which can reduce an inductance and a ripple current to reduce power loss and equipment cost. The charging control method has high battery charging efficiency, and the power supply equipment can be subjected to voltage regulation.

### BRIEF DESCRIPTION OF THE DRAWINGS

FIG. 1 is a schematic diagram of Embodiment I of power supply equipment of the present disclosure;

FIG. 2 is a schematic diagram of Embodiment II of the power supply equipment of the present disclosure;

FIG. 3 is a schematic diagram of Embodiment I of a switched capacitor converter of the present disclosure;

FIG. 4 is a schematic diagram of Embodiment II of the switched capacitor converter of the present disclosure; and

FIG. 5 is a schematic diagram of a linear regulator of the present disclosure.

### DETAILED DESCRIPTION OF THE EMBODIMENTS

The preferred embodiments of the present disclosure are described in detail below with reference to the drawings, but the present disclosure is not limited to these embodiments. The present disclosure covers any substitution, modification, equivalent method and solution made within the spirit and scope of the present disclosure.

For a better understanding of the present disclosure, the specific details of the following preferred embodiments of the present disclosure are explained hereinafter in detail, while the present disclosure can also be fully understood by those skilled in the art without the description of these details.

The present disclosure is described in detail by giving examples with reference to the drawings. It should be noted that the drawings are simplified and do not use an accurate proportion, that is, the drawings are for the objectives of conveniently and clearly assisting in illustrating embodiments of the present disclosure.

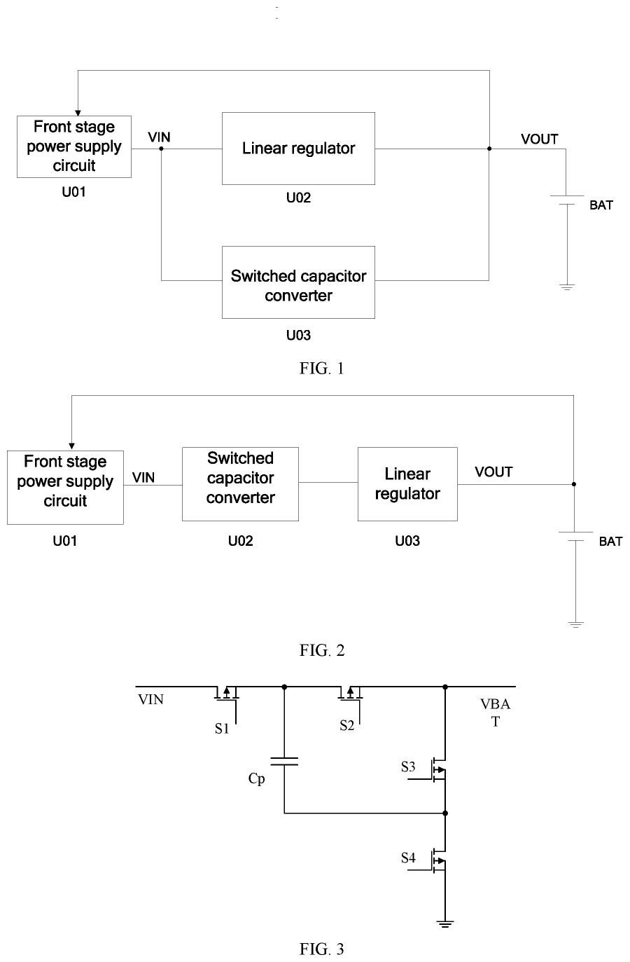

As shown in FIG. 1, a schematic diagram of Embodiment I of power supply equipment of the present disclosure is illustrated. A front stage power supply circuit U01 (such as an adapter, a wireless charging receiving terminal) charges a battery through a power circuit. The power circuit is a parallel circuit composed of a switched capacitor converter U03 and a linear regulator U02. The front stage power supply circuit adjusts an input voltage of the power circuit according to a voltage of the battery. The input voltage of the power circuit generally increases with the voltage of the battery, such that power loss of the linear regulator and the switched capacitor converter is small during operation. During charging, the battery is first charged in a trickle mode, then enters into a constant current charging mode, and finally enters into a constant voltage charging mode when the battery is nearly fully charged. When the battery is charged at high power, such as in the battery constant current charging mode, the switched capacitor converter is selected for charging management, the linear regulator is disabled, and the input voltage of the power circuit increases with the voltage of the battery, generally linearly or stepwise, such that the input voltage of the power circuit varies between 100% to 110% of the product of the voltage of the battery and an ideal conversion ratio of the switched capacitor (such as 2:1). When the battery is charged at low power, such as in the battery constant voltage mode, the linear regulator is selected for charging management, the switched capacitor converter is disabled, and the input voltage of the power circuit is adjusted in time so that the input voltage of the power circuit is slightly greater than a sum of the voltage of the battery and a voltage drop of the linear regulator. When the battery is charged in the trickle mode or just enters the battery constant current charging mode, the power is high, and the switched capacitor converter or the linear regulator can be selected for charging management according to the needs.

As shown in FIG. 2, a schematic diagram of Embodiment II of power supply equipment of the present disclosure is illustrated. A front stage power supply circuit U01 (such as an adapter, a wireless charging receiving terminal) charges a battery through a power circuit. The power circuit is a series circuit composed of a switched capacitor converter U02 and a linear regulator U03. The front stage power supply circuit adjusts an input voltage of the power circuit according to a voltage of the battery. The input voltage of the power circuit generally increases with the voltage of the battery, such that power loss of the linear regulator and the switched capacitor converter is small during operation. When the charging power is high, such as in the battery constant current charging mode, the switched capacitor converter performs charging management, and the input voltage of the power circuit is adjusted in time such that the input voltage of the power circuit varies between 100% and 110% of a sum of the product of voltage of the battery * an ideal conversion ratio of the switched capacitor (such as 2:1) and a voltage drop of the linear regulator. At this time, the linear regulator can operate in a direct mode without participating in charging, and the efficiency is highest. Alternatively, the linear regulator can operate in a linear adjustment mode with participating in control of the charging current, and can accurately control the charging current. When the linear regulator operates in the linear adjustment mode, it is necessary to ensure that the voltage drop of the linear regulator is small and within a certain range. When the charging power is low, such as in the battery constant voltage charging mode, the linear regulator performs charging management, and the input voltage of the power circuit is adjusted in time, such that the input voltage of the power circuit is slightly higher than a sum of the voltage of the battery, the voltage drop of the linear regulator and the voltage drop of the switched capacitor converter, and at this time, the switched capacitor converter is in a direct mode and does not participate in charging management. When the battery is charged in the trickle mode or just enters the battery constant current charging mode, the power is high, and the switched capacitor converter and/or the linear regulator can be selected for charging management according to the needs.

In the embodiments illustrated in FIG. 1 and FIG. 2, switched capacitor converters with different conversion ratios (such as 2:1, 3:1, 4:1, . . . , and n:1, and n is a positive integer) can be selected according to the charging power and the charging current. The linear regulator and the switched capacitor converter can be integrated in a single system or chip, or can be separated into two systems or two chips. When the switched capacitor converter and the linear regulator do not operate simultaneously, switching elements of input and output channels of the switched capacitor converter can be reused in the linear charging mode, and reused as a linear charging power device when switching to the linear charging mode, which eliminates the need for additional linear charging units or power devices in series.

As shown in FIG. 3, a schematic diagram of Embodiment I of a switched capacitor converter of the present disclosure is illustrated, which is a three-level voltage conversion circuit, including a first switch S1, a second switch S2, a third switch S3, a fourth switch S4, and a capacitor Cp. The first switch S1, the second switch S2, the third switch S3 and the fourth switch S4 are connected in sequence. A first terminal of the capacitor Cp is connected with a common connection terminal of the first switch S1 and the second switch S2, and a second terminal of the capacitor Cp is connected with a common connection terminal of the third switch S3 and the fourth switch S4. The first switch S1 receives an input voltage VIN. The common connection terminal of the second switch S2 and the third switch S3 is an output terminal, which is connected to the battery. When the switches S1 and S3 are turned on, Vin=Vcp+Vo. When the switches S2 and S4 are turned on, Vcp=Vo. When it is steady, Vo=Vin/2.

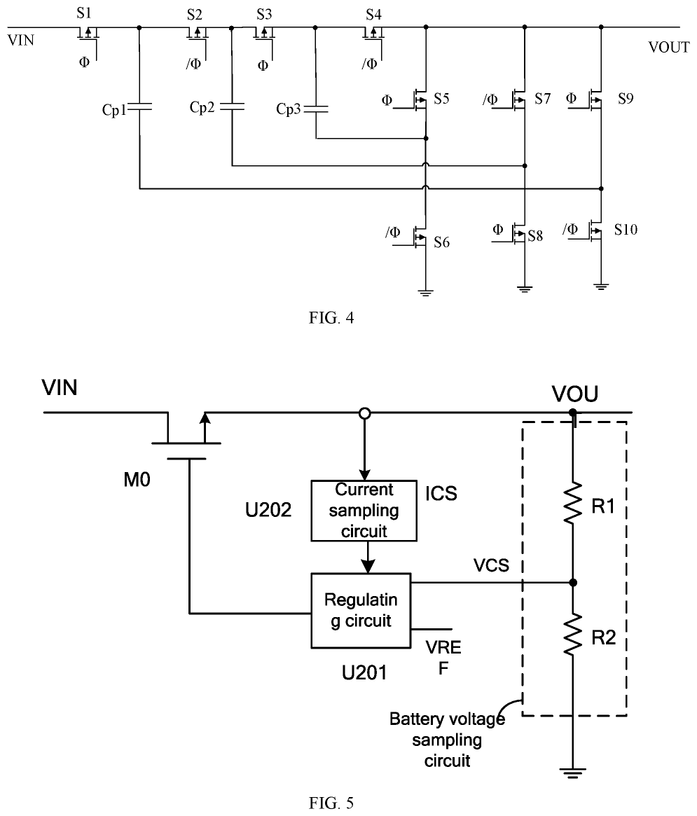

As shown in FIG. 4, a schematic diagram of Embodiment II of the switched capacitor converter of the present disclosure is illustrated, which is a five-level voltage conversion circuit, including 10 switches from S1 to S10, and capacitors Cp1, Cp2, and Cp3. The switches S1, S2, S3, and S4 are connected in sequence. The switch S5 is connected to the switch S4. The switch S6 is connected to the switch S5 and grounded. The switch S7 is connected to the switch S4. The switch S8 is connected to the switch S7 and grounded. The switch S9 is connected to the switch S4. The switch S10 is connected to the switch S9 and grounded. The capacitor Cp1 includes one terminal connected with a common connection terminal of S1 and S2, and the other terminal connected with a common connection terminal of S9 and S10. The capacitor Cp2 includes one terminal connected with a common connection terminal of S2 and S3, and the other terminal connected with a common connection terminal of S7 and S8. The capacitor Cp3 includes one terminal connected with a common connection terminal of S3 and S4, and the other terminal connected with a common connection terminal of S5 and S6. When the switches S1, S3, S5, S8, and S9 are turned on, Vin=Vcp1+Vo, and Vcp2=Vcp3+Vo. When the switches S2, S4, S6, S7, and S10 are turned on, Vcp1=Vcp2+Vo, and Vcp3=Vo. When it is in a steady state, Vo=Vcp3=Vin/4, Vcp2=Vin/2, and Vcp1=3*Vin/4.

As shown in FIG. 4, a schematic diagram of a linear regulator of the present disclosure is illustrated, which includes a power transistor M0, a battery voltage sampling circuit, a charging current sampling circuit U202, and a regulating circuit U201. The voltage of the battery is sampled through divider resistors R1 and R2, and a voltage at a connection terminal of the resistors R1 and R2 is a battery voltage sampling signal. The charging current sampling circuit samples a charging current. The regulating circuit U201 receives a battery voltage sampling signal VCS, a battery voltage reference signal VREF, and a battery charging current ICS, and outputs a control signal. The power transistor M0 includes one terminal connected with the input power supply, and the other terminal connected with an anode of the battery, and a control terminal of the power transistor is connected with an output terminal of the regulating circuit U201. The linear regulator controls an operating state of the power transistor M0 according to its connection relationship with the switched capacitor converter, an error between the output voltage and the reference voltage, and the charging current, such that the linear regulator operates in a required state.

Although the embodiments are separately illustrated and described above, the embodiments contain some common technologies. Those skilled in the art can replace and integrate the embodiments. Any content not clearly recorded in one of the embodiments may be determined based on another embodiment where the content is recorded.

The embodiments described above do not constitute a limitation on the scope of protection of the technical solution of the present disclosure. Any modification, equivalent replacement, and improvement made within the spirit and principle of the above-mentioned embodiments shall fall within the scope of protection of the technical solution of the present disclosure.

What is claimed is:

1. A charging control method of a power supply equipment, wherein the power supply equipment comprises a power stage circuit and a battery, an input power supply charges the battery through the power stage circuit, the power stage circuit comprises a linear regulator and a switched capacitor converter, the linear regulator is connected with the switched capacitor converter, and the linear regulator and/or the switched capacitor converter are/is selected for a battery charging management according to a charging power of the battery and/or a voltage of the battery.

2. The charging control method of the power supply equipment according to claim 1, comprising: sampling the voltage of the battery, adjusting an input voltage of the power stage circuit according to the voltage of the battery, wherein when the switched capacitor converter performs the battery charging management, a ratio of the input voltage of the power stage circuit to the voltage of the battery is within a first range; and when the linear regulator performs the battery charging management, the ratio of the input voltage of the power stage circuit to the voltage of the battery is within a second range.

3. The charging control method of the power supply equipment according to claim 1, wherein when the switched capacitor converter performs charging, an input voltage of the power stage circuit increases with the voltage of the battery.

4. The charging control method of the power supply equipment according to claim 3, wherein the input voltage of the power stage circuit increases stepwise with the voltage of the battery.

5. The charging control method of the power supply equipment according to claim 2, wherein the linear regulator is connected in parallel with the switched capacitor converter.

6. The charging control method of the power supply equipment according to claim 5, wherein when charging the battery in a constant current charging mode, the switched capacitor converter performs the battery charging management, and the linear regulator is disabled.

7. The charging control method of the power supply equipment according to claim 6, wherein the first range is set according to a power loss of battery charging and a conversion ratio of the input voltage of the power stage circuit to the voltage of the battery.

8. The charging control method of the power supply equipment according to claim 5, wherein when charging the battery in a constant voltage charging mode, the linear regulator performs the battery charging management, and the switched capacitor converter is disabled.

9. The charging control method of the power supply equipment according to claim 2, wherein the linear regulator is connected in series with the switched capacitor converter.

10. The charging control method of the power supply equipment according to claim 9, wherein when charging the battery in a constant current charging mode, the switched capacitor converter performs the battery charging management, the linear regulator operates in a direct mode and does not participate in the battery charging management, alternatively, the linear regulator operates in a linear adjustment mode and participates in the battery charging management.

11. The charging control method of the power supply equipment according to claim 10, wherein when the linear regulator operates in a linear adjustment mode, a voltage drop of the linear regulator is within a third range.

12. The charging control method of the power supply equipment according to claim 10, wherein the input voltage of the power stage circuit is adjusted according to the voltage of the battery, and the first range is set according to a power loss of battery charging, a voltage drop of the linear regulator, and a conversion ratio of the input voltage of the power stage circuit to the voltage of the battery.

13. The charging control method of the power supply equipment according to claim 9, wherein when charging the battery in a constant voltage charging mode, the linear regulator performs the battery charging management, and the switched capacitor converter operates in a direct mode and does not participate in the battery charging management.

14. The charging control method of the power supply equipment according to claim 1, wherein when the linear regulator and the switched capacitor converter do not operate simultaneously, at least one switching device in the switched capacitor converter is reused as a power device of the linear regulator.

15. A power supply equipment, comprising a power stage circuit and a battery, wherein the battery is charged through the power stage circuit, the power stage circuit comprises a linear regulator and a switched capacitor converter, the linear regulator is connected in parallel or in series with the switched capacitor converter, and the linear regulator and/or the switched capacitor converter are/is selected for a battery charging management according to a charging power of the battery and/or a voltage of the battery.

16. The power supply equipment according to claim 15, wherein the voltage of the battery is sampled, an input voltage of the power stage circuit is adjusted according to the voltage of the battery, and when the switched capacitor converter performs the battery charging management, a ratio of the input voltage of the power stage circuit to the voltage of the battery is within a first range; and when the linear regulator performs the battery charging management, the ratio of the input voltage of the power stage circuit to the voltage of the battery is within a second range.

17. The power supply equipment according to claim 16, wherein when the switched capacitor converter performs charging, the input voltage of the power stage circuit increases with the voltage of the battery.

18. The power supply equipment according to claim 15, wherein when the linear regulator is connected in parallel with the switched capacitor converter, when charging the battery in a constant current charging mode, the switched capacitor converter performs the battery charging management, and the linear regulator is disabled; and when charging the battery in a constant voltage charging mode, the linear regulator performs the battery charging management, the switched capacitor converter is disabled.

19. The power supply equipment according to claim 15, wherein when the linear regulator is connected in series with the switched capacitor converter, when charging the battery in a constant current charging mode, the switched capacitor converter performs the battery charging management, the linear regulator operates in a direct mode or in a linear adjustment mode; when charging the battery in a constant voltage charging mode, the linear regulator performs the battery charging management, and the switched capacitor converter operates in a direct mode.

20. The power supply equipment according to claim 15, wherein the switched capacitor converter comprises at least one capacitor and at least a first switch transistor, a second switch transistor, a third switch transistor, and a fourth switch transistor, the first switch transistor, the second switch transistor, the third switch transistor and the fourth switch transistor are connected in sequence, a first terminal of the first switch transistor receives an input voltage of the power stage circuit, a second common connection terminal of the second switch transistor and the third switch transistor is connected to the battery; the at least one capacitor comprises a first terminal connected with a first common connection terminal of the first switch transistor and the second switch transistor, and a second terminal connected with a third common connection terminal of the third switch transistor and the fourth switch transistor; when charging the battery in a constant current charging mode, the switched capacitor converter performs the battery charging management.
